(19) United States
(12) Patent Application Publication
(10) Pub. No.: US 2026/0146851 A1
(43) Pub. Date: May 28, 2026

(54) METHOD OF CONTACTLESS VEHICLE TOE ANGLE MEASUREMENT

(71) Applicant: UVeye Ltd., Tel Aviv (IL)

(72) Inventors: Guy ENGEL, Herzliya (IL); Amir HEVER, Tenafly, NJ (US); Itai ORR, Or Akiva (IL); Amit KONSTABLER, Tzur Yizhak (IL)

(73) Assignee: UVeye Ltd., Tel Aviv (IL)

(21) Appl. No.: 18/957,776

(22) Filed: Nov. 24, 2024

(51) Int. Cl. G01B 11/275

(52) U.S. Cl. CPC G01B 11/275; G01B 2210/14

(57) ABSTRACT

System and method for a computer vision technique for contactless measurement of vehicle toe are disclosed herein. The method includes capturing with a stereo camera an image containing a vehicle's wheel, segmenting the image, determining a suitable circular component of the wheel and computing the angle of the wheel relative to the camera and, subsequently, to the body of the vehicle. The method includes repeating the process for a plurality of wheels and computing the toe angle of the vehicle based on the obtained results.

### FIELD AND BACKGROUND OF THE INVENTION

The present invention, in some embodiments thereof, relates to computer vision techniques and, more particularly, but not exclusively, to computer vision techniques for contactless measurement of vehicle toe angle.

In the field of automotive engineering, the toe angle denotes the symmetric angle between the vertical axis of a wheel and the longitudinal axis of a vehicle—i.e. the line connecting the midpoint in the back of the vehicle to the midpoint in the front of the vehicle viewed in the top-down projection. Symmetry of toe means that the left and right wheels in a pair are rotated along the corresponding vertical axes in opposite directions—i.e. clockwise and counter-clockwise. This stands in contrast with the anti-symmetric steering angle, which causes the wheels in a pair to turn in a common direction.

While changing the steering angle is an essential maneuver and an integral part of driving a wheeled vehicle, adjusting the toe angle is a considered a maintenance operation performed primarily at car dealerships, service tech centers and similar facilities, and requires a special alignment machine. Depending on the vehicle dimensions and its characteristics, such as whether it is a front-wheel drive or a rear-wheel drive vehicle, as well as its expected usage patterns, stability, maneuverability and wear rate requirements, different values of negative or positive toe may be configured.

To properly configure a toe angle, it is essential that the alignment machine may determine its value with high precision, as normally toe values are rather small (often around 0.2 to 0.4 degrees). There are multiple approaches to solving this problem; most of them require mounting a mechanical device on a wheel (either on its metal frame or on the tire), which leads to increase in labor intensity of the measurement process and detrimentally affects execution speed, while many others employ expensive components such as lidars or multiple high-precision cameras; some methods possess both of these drawbacks simultaneously. Therefore, there is a demand for a toe angle measurement technique that is sufficiently precise, does not require expensive machinery and can be operated in a contactless fashion—without mounting any devices whatsoever on vehicle wheels. Such a technique would greatly streamline operations at a maintenance center and increase service throughput, while simultaneously reducing operational costs. Such a technique could also be beneficial in a vehicle manufacturing facility for quality control purposes.

### SUMMARY OF THE INVENTION

According to an aspect of some embodiments of the present invention there is provided a method for determining wheel alignment of a motor vehicle. The method comprises: obtaining, with one or more cameras, an image depicting at least in part a wheel of a vehicle; analyzing the image to identify a circular component of the wheel depicted in the image; determining a desired number of sampled points lying on an edge of the circular component; determining an elliptic shape corresponding to the edge of the circular component; determining an angle of the wheel depicted in the image respective to the one or more cameras as a function of geometric properties of the elliptic shape; performing the previous steps for each wheel of the motor vehicle; determining a left toe angle as a difference between the angles of the front left and rearmost left wheels; determining a right toe angle as a difference between the angles of the front right and rearmost right wheels; and outputting a sum of the left toe angle and the right toe angle.

Optionally, determining a desired number of sampled points comprises determining a total number of pixels corresponding to the edge of the circular component and dividing the total number of pixels corresponding to the edge of the circular component by a predetermined factor.

Optionally, determining a desired number of sampled points lying on an edge of the circular component and determining an elliptic shape corresponding to the edge of the circular component comprises: sampling a subset of points corresponding to the edge of the circular component according to a total number of pixels corresponding to the edge of the circular component and a sampling factor; determining an elliptic shape corresponding to the sampled subset of points corresponding to the edge of the circular component; calculating an error metric of the elliptic shape relative to the sampled points on the edge of the circular component of the wheel segment and responsive to a predetermined convergence condition being met, outputting the elliptic shape, otherwise reducing the sampling factor and repeating the previous steps.

Optionally, the error metric comprises a median Euclidean distance between points comprising the elliptic shape and respective closest points comprising the edge of the circular component.

Optionally, determining the elliptic shape at least in part comprises the least squares method.

Optionally, determining the elliptic shape at least in part comprises the random sample consensus method.

Optionally, the circular component comprises a center cap of a hubcap of the wheel.

Optionally, the circular component comprises an entirety of a hubcap of the wheel.

Optionally, the circular component comprises a rim flange of the wheel.

According to an aspect of some embodiments of the present invention there is provided a method for determining wheel alignment of a motor vehicle. The method comprises: obtaining a first image depicting at least in part a first wheel of a vehicle with a first stereo camera and a second image depicting at least in part a second wheel of the vehicle with a second stereo camera, wherein the first wheel and the second wheel are located on opposite sides of the vehicle; analyzing the first image and the second image to determine a plane of the first wheel and a plane of the second wheel, respectively; determining a first normal to the plane of the first wheel and a second normal to the plane of the second wheel; determining a first angle between the first normal and the plane of the second wheel and a second angle between the second normal and the plane of the first wheel; and outputting a difference between the first angle and the second angle.

According to an aspect of some embodiments of the present invention there is provided a method for determining wheel alignment of a motor vehicle. The method comprises: obtaining a first image depicting at least in part a first wheel of a vehicle and a fixed entity parallel to a longitudinal axis of the vehicle with a first stereo camera and a second image depicting at least in part a second wheel of the vehicle and the fixed entity parallel to a longitudinal axis of the vehicle with a second stereo camera, wherein the first wheel and the second wheel are located on opposite sides of the vehicle; analyzing the first image and the second image to determine a plane of the first wheel, a plane of the second wheel, and a plane of the fixed entity, respectively; determining a first normal to the plane of the first wheel and a second normal to the plane of the second wheel; determining a first angle between the first normal and the plane of the fixed entity and a second angle between the second normal and the plane of the fixed entity; and outputting a sum of the first angle and the second angle.

According to an aspect of some embodiments of the present invention there is provided a computer system, comprising: a processor configured to execute stored executable instructions and a non-transitory computer readable medium storing executable instructions that, when executed by a processor, cause the computer system to perform a method for determining wheel alignment of a motor vehicle, the method comprising: obtaining, with one or more cameras, an image depicting at least in part a wheel of a vehicle; analyzing the image to identify a circular component of the wheel depicted in the image; determining a desired number of sampled points lying on an edge of the circular component; determining an elliptic shape corresponding to the edge of the circular component; determining an angle of the wheel depicted in the image respective to the one or more cameras as a function of geometric properties of the elliptic shape; performing the previous steps for each wheel of the motor vehicle; determining a left toe angle as a difference between the angles of the front left and rearmost left wheels; determining a right toe angle as a difference between the angles of the front right and rearmost right wheels and outputting a sum of the left toe angle and the right toe angle.

According to an aspect of some embodiments of the present invention there is provided a contactless vehicle wheel toe angle measurement device, comprising: one or more cameras configured to capture an image depicting a wheel of a vehicle; a processor configured to execute stored executable instructions and a non-transitory computer readable medium storing executable instructions that, when executed by a processor, cause the computer system to perform a method for determining wheel alignment of a motor vehicle, the method comprising: obtaining, with one or more cameras, an image depicting at least in part a wheel of a vehicle; analyzing the image to identify a circular component of the wheel depicted in the image; determining a desired number of sampled points lying on an edge of the circular component; determining an elliptic shape corresponding to the edge of the circular component; determining an angle of the wheel depicted in the image respective to the one or more cameras as a function of geometric properties of the elliptic shape; performing the previous steps for each wheel of the motor vehicle; determining a left toe angle as a difference between the angles of the front left and rearmost left wheels; determining a right toe angle as a difference between the angles of the front right and rearmost right wheels and outputting a sum of the left toe angle and the right toe angle.

Optionally, the device further comprises a mechanical mount, wherein the one or more cameras are installed on the mechanical mount, the mechanical mount being configured to reposition the one or more cameras along the longitudinal axis of the vehicle.

Optionally, the mechanical mount comprises a conveyor belt system.

Optionally, the mechanical mount comprises a linear actuator system.

Optionally, the mechanical mount comprises a sliding rail system.

Optionally, the device further comprises a mechanical mount, wherein the one or more cameras are installed on the mechanical mount, the mechanical mount being configured to reposition the one or more cameras at least in part along both the longitudinal and the lateral axes of the vehicle.

Optionally, the mechanical mount comprises a robotic arm with at least one degree of freedom.

Optionally, the mechanical mount comprises an overhead gantry system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a vehicle toe angle, according to some embodiments of the invention;

FIG. 2 is a schematic illustration of an example setup of a contactless system for measuring a vehicle toe angle, according to some embodiments of the invention;

FIG. 3 is a schematic illustration of a segmented vehicle undercarriage image, according to some embodiments of the invention;

FIG. 4 an example workflow of a contactless system for measuring a vehicle toe angle, according to some embodiments of the invention; and

FIG. 5 is a schematic illustration of a vehicle wheel and a superimposed best-fit elliptic shape, according to some embodiments of the invention.

### DESCRIPTION OF SPECIFIC EMBODIMENTS OF THE INVENTION

The present invention, in some embodiments thereof, relates to computer vision techniques and, more particularly, but not exclusively, to computer vision techniques for contactless measurement of vehicle toe angle.

As used herein, the term toe denotes the angle between the central plane of a vehicle, in the longitudinal direction, with the line of intersection of the central plane of one of the wheels with the ground plane.

According to one of the methods disclosed in the present application, the vehicle toe is measured by capturing images of a vehicle wheel with a camera, utilizing computer vision techniques to calculate the geometric properties of the wheel, computed its angle relative to the camera, performing this process for all wheels of the vehicle and using the computed wheel angle values to compute the vehicle toe.

The present invention offers several notable advantages and improvements over the state of the art methods of measuring vehicle toe. First, many existing methods rely on mounting hardware implements onto vehicle wheels. In some cases such implements are attached to metal components of the wheel such as the disc or the rim, contributing to their wear, while in other cases such implements are attached to the tire. Regardless of the exact mount point the process of mounting, aligning and subsequently removing such hardware implements inherently requires manual labor and time; contactless methods do not possess this drawback. Simultaneously, existing contactless methods rely on utilizing LIDAR which remains a relatively expensive device. The present invention discloses a contactless method which does not utilize expensive hardware and may be assembled using off-the-shelf camera products.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

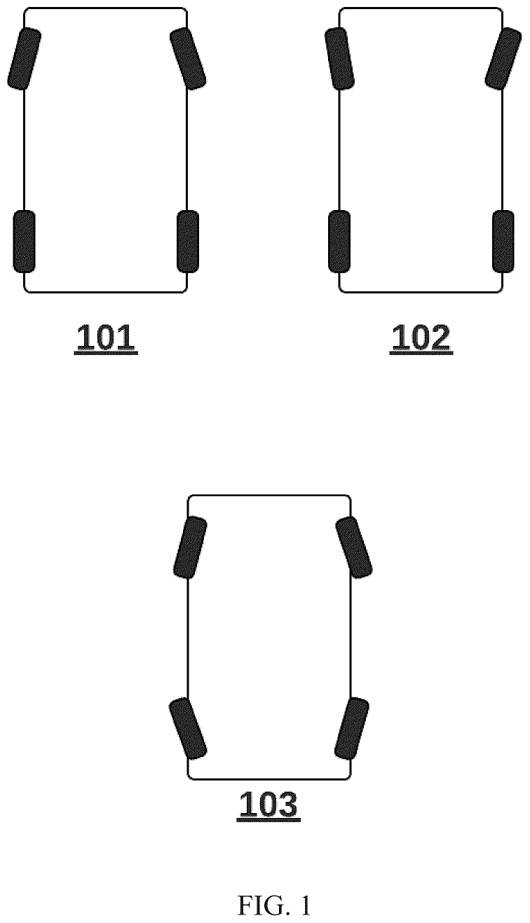

Referring now to the drawings, FIG. 1 illustrates a top-down schematic view of a four-wheeled vehicle. According to some embodiments of the invention, 101 represents a case of positive front toe, or toe-in, 102 represents a case of negative front toe, or toe-out, and 103 represents a case of a positive front toe in conjunction with a positive rear-toe. The toe angles are greatly exaggerated for clarity.

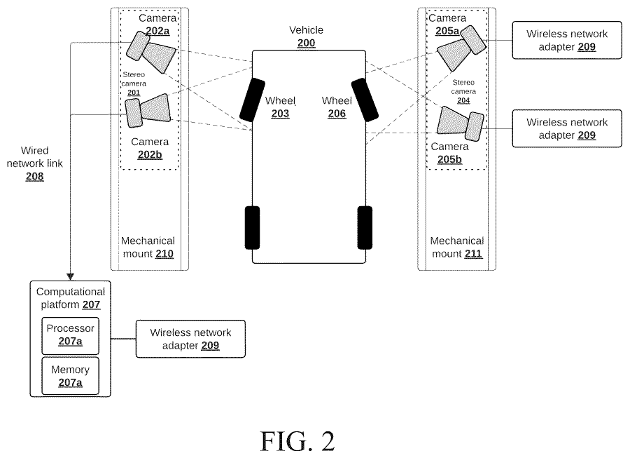

FIG. 2 illustrates an example setup of a contactless system for measuring toe angle of a vehicle 200. According to some embodiments of the invention, a first stereo camera 201 comprising cameras 202a and 202b captures an image of a first wheel 203 of the vehicle 200, and a second stereo camera 204 comprising cameras 205a and 205b captures an image of a second wheel 206 of the vehicle 200.

In another embodiment, stereo cameras 201 and 204 are installed on a mechanical mount 210 and 211, enabling it to reposition the respective stereo cameras 201 and 204 at least in part alongside the longitudinal axis of the vehicle 200. Examples of such a mechanical mount include a conveyor belt, a linear actuator system, or a sliding rail system.

In another embodiment, the system comprises a stereo camera 201 installed on a mechanical mount 210, enabling it to reposition the stereo camera 201 at least in part along the longitudinal and the lateral axes of a vehicle 200. Examples of such a mechanical mount include a robotic arm with at least one degree of freedom or an overhead gantry system.

In another embodiment, the system comprises at least four stereo cameras 201, enabling the system to simultaneously observe four wheels of the vehicle 200.

In another embodiment, the system comprises a computational platform 207 connected to at least one stereo camera 201 over a wired network link 208, enabling it to transmit image data to the computational platform 207 for further processing as described hereinbelow. The computational platform 207 in turn comprises a processor 207a and a non-transitory computer readable medium 207b storing the instructions to be executed by the processor 207a.

In another embodiment, the system comprises a computational platform 207 connected to at least one a stereo camera 204 over a wireless network link via wireless network adapters 209, enabling it to transmit image data to the computational platform 207 for further processing as described hereinbelow.

In an embodiment, the computational platform 207 comprises a dedicated computer in the same local network and physical location as the stereo cameras 201 and 204. In another embodiment, the computational platform 207 comprises a remote server, a cloud instance, a serverless execution environment, or other type of computational resource.

As used herein, a segmented image is a digital representation wherein an image is divided into one or more distinct regions or segments delineated based on predetermined criteria such as color, intensity, texture, or other distinguishing attributes. As used herein, segmentation is the process of constructing a segmented image based on an input of a raster image.

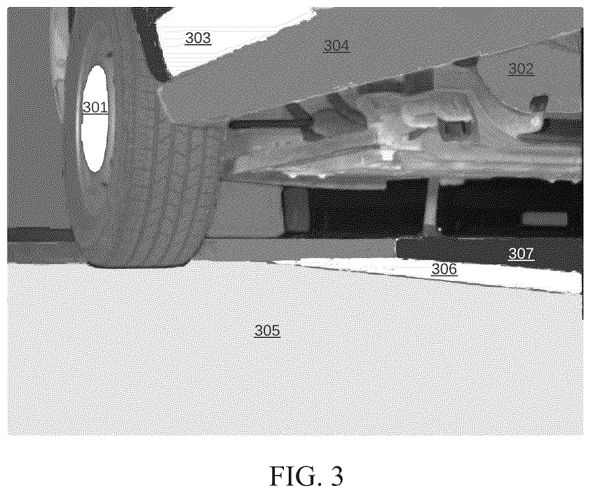

By the way of example, FIG. 3 is a schematic illustration of a segmented image of undercarriage of a vehicle 200. According to some embodiments of the invention, the segmented image comprises a wheel hubcap 301, miscellaneous components 302, 303 and 304 of the vehicle 200, and sections of the floor 305, 306 and 307.

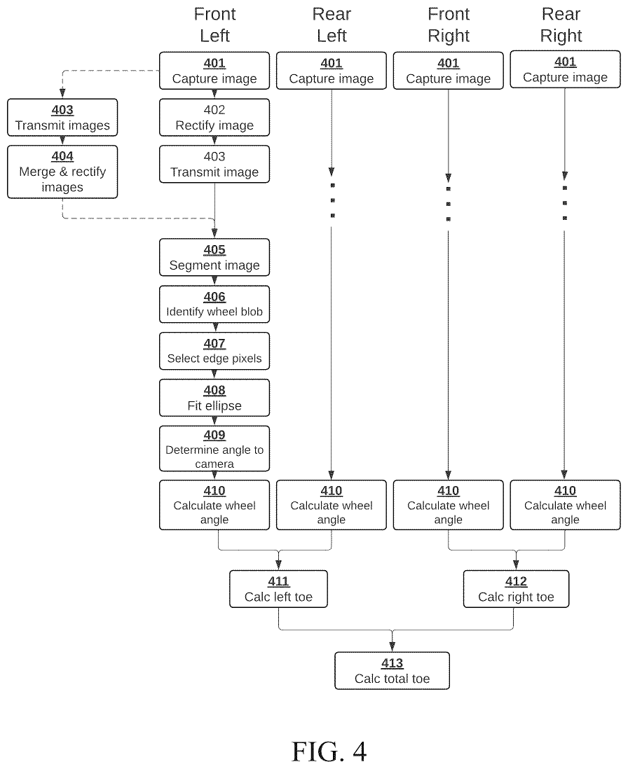

FIG. 4 illustrates an example workflow of a contactless system for measuring a vehicle toe angle. According to some embodiments of the invention, a first stereo camera 201 captures 401 an image of a wheel 203 and performs 402 rectification of the image according to the calibration parameters of the first stereo camera 201 and/or other parameters, and transmits 403 the image to a computational platform 207 over a wired or a wireless link. In another embodiment, the first stereo camera 201 transmits 403 separate images captured by distinct camera units 202a and 202b to the computational platform 207; the computational platform 207 subsequently performs 404 processing such as merging and rectification of the images. The computational platform 207 subsequently performs 405 segmentation of a processed image and identifies 406 blobs corresponding to the tire, the hubcap, or other component of the wheel 203, and selects 407 a desired number of pixels belonging to the edge of the chosen component of the wheel 203. The computational platform 207 subsequently determines 408 an elliptic shape corresponding to the edge of the circular component configured for further processing, determines 409 the angle of the wheel 203 depicted in the image respective to the first stereo camera 201 as a function of the geometric properties of the elliptic shape, and computes 410 the angle of the wheel 203 relative to the longitudinal axis of the vehicle 200:

$$A = arccos \frac{a}{b} ,$$

where a and b are the semi-minor and semi-major axis lengths of the resultant elliptic shape, respectively.

In a further embodiment, the computational platform 207 computes 410 the angle of the wheel 203 relative to the longitudinal axis of the vehicle 200 considering a non-zero camber angle θ:

$$A = arccos \frac{{a}_{1}}{{b}_{1}} ,$$

where

$${a}_{1} = \sqrt{{h}_{a}^{2} + \frac{{v}_{a}^{2}}{{sin}^{2} θ}} , and {b}_{1} = \sqrt{{h}_{b}^{2} + \frac{{v}_{b}^{2}}{{sin}^{2} θ}} ,$$

hₐ, h_{b} are the horizontal components, and vₐ, v_{b} are the vertical components of the semi-minor and semi-major axis lengths of the resultant elliptic shape, respectively.

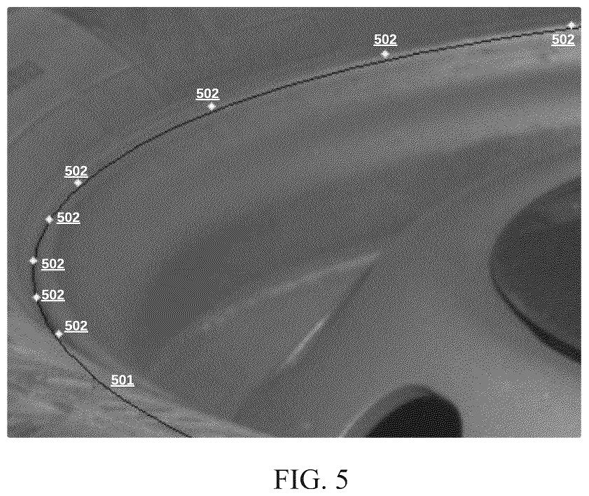

FIG. 5 schematically illustrates a portion of a processed image of a wheel. According to some embodiments of the invention, 501 is a superimposed elliptic shape corresponding to the edge of the rim flange as determined according to selected pixels 502 belonging to the rim flange.

In another embodiment, the circular component of the wheel configured for further processing may be the entirety of the hubcap.

In another embodiment, the circular component of the wheel configured for further processing may be the center cap of the hubcap.

In another embodiment, the circular component of the wheel configured for further processing may be the rim flange of the wheel.

In an embodiment, the computational platform 207 may configure the desired number of sampled points (pixels) to use for the subsequent fitting of the elliptic shape based on a preconfigured value.

In another embodiment, the computational platform 207 may configure the number of sampled points to use for the subsequent fitting of the elliptic shape based on the total resolution of the image or the visual size of the circular component of the wheel. In an example, the computational platform 207 may determine that the edge of the circular component comprises N pixels, and use

$$round ( \frac{N}{m} )$$

as the desired number of sampled points, where m≥1 is a preconfigured factor.

In another embodiment, the computational platform 207 may configure the number of sampled points to use for the subsequent fitting of the elliptic shape based on fitting error convergence criteria. If an optimal number of points to be used is not known in advance, it may be determined by running the process of sampling the points on the edge of the circular component and fitting an elliptic shape to it multiple times, recording the variance of error metric values produced by several process runs performed with a same number of sampled points, and increasing it by a preconfigured factor or increment if the variance does not satisfy the convergence criteria.

In a further embodiment, the error metric comprises the median Euclidean distance between the points comprising the elliptic shape and closest points comprising the edge of the circular component.

In a further embodiment, the error metric comprises the mean Euclidean distance between the points comprising the elliptic shape and closest points comprising the edge of the circular component.

In another embodiment, the computational platform 207 is configured to store a threshold error metric value, and terminates the process with an error if fitting an elliptic shape to the edge of the circular component fails to converge to a state producing an error metric value below the threshold value.

In another embodiment, the computational platform 207 may perform the process described hereinabove for multiple circular components of a same wheel and use the resulting angle value of the process run returning the lowest error metric value. In an example, the computational platform 207 performs the process described hereinabove for both the rim flange and the hubcap of a same wheel.

In a further embodiment, the computational platform 207 uses the RANSAC (random sample consensus) method to fit an elliptic shape to the sampled points on the edge of the circular component.

In a further embodiment, the computational platform 207 uses the least squares method to fit an elliptic shape to the sampled points on the edge of the circular component.

In a further embodiment, the computational platform 207 performs the process described hereinabove individually for one or more wheels as necessary to compute the toe of the vehicle 200. In an example, for a four-wheel motor vehicle the computational platform 207 performs the process described hereinabove to determine the angles of the front left, front right, rear left and rear right wheels. The computational platform 207 subsequently determines the left toe angle 411 as a difference between the angles of the front left and rear left wheels, and determines the right toe angle 412 as a difference between the angles of the front right and rear right wheels, and computes 413 the total toe as the sum of the left toe angle and the right toe angle:

$${TOE}_{right} = {A}_{frontright} - {A}_{rearright}$$

$${TOE}_{left} = {A}_{frontleft} - {A}_{rearleft}$$

$$TOE = {TOE}_{right} + {TOE}_{left} .$$

In an another embodiment, the stereo cameras 201 and 204 possess identical calibration parameters, and the toe angle calculation may rely on combined data captured by the cameras. The computational platform 207 analyzes the image of the first wheel 203 and the image of the second wheel 206 to identify the depth of each of a plurality of pixels depicting the first wheel 203 and the second wheel 206, respectively. The computational platform 207 further determines the plane of the first wheel 203 and the second wheel 206, which may comprise the front left wheel and the front right wheel or the rear left and the rear right wheel, respectively. The computational platform 207 further determines normal directions to the planes corresponding to each of the first wheel and the second wheel. The computational platform 207 further computes projections of the normals to the planes of the wheels 203, 206 onto planes of the opposite wheels 206, 203, respectively, and determines the angles between the projected normals and the respective planes. The computational platform 207 then computes the total toe as the difference between the determined angles:

$$TOE = {A}_{nproj 1} - {A}_{nproj 2}$$

In an another embodiment, the stereo cameras 201 and 204 possess differing calibration parameters, requiring that the toe angle calculation is performed separately for each wheel, and the images obtained by the first camera 201 and the second camera 204 depict at least in part a fixed entity 307 positioned parallel to the vehicle's 200 longitudinal axis. The images obtained by separate cameras may depict the same or different entities 307. The computational platform 207 analyzes the image of the first wheel 203 and the image of the second wheel 206 to identify the depth of each of a plurality of pixels depicting the first wheel 203 and the second wheel 206, respectively, as well as the depth of a plurality of pixels depicting the fixed entity 307. The computational platform 207 further determines the plane of the first wheel 203, the second wheel 206, and the fixed entity 307 in the images obtained by the first camera 201 and the second camera 204. The computational platform 207 further computes projections of the normals to the planes of the wheels 203, 206 onto the planes of the fixed entity 307 as observed by each camera 201, 204 separately, and determines the angles between the projected normals and the respective planes. The computational platform 207 then computes the total toe as the sum of the determined angles:

$$TOE = {A}_{nproj 1} + {A}_{nproj 2}$$

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Examples

Reference is now made to the following examples, which together with the above descriptions illustrate some embodiments of the invention in a non-limiting fashion.

In the example experiment, the rim flange was utilized as the circular wheel component to be tracked, and a total of 16 measurements were conducted. A total of 64 images were captured—one stereo-pair image per each wheel. In each image, 20 points were manually marked on the circular component for validating the ellipse constructed using least square ellipse fitting and determining the average pixel error size.

Operationally, a measurement involves a vehicle driving into the appropriately set up zone equipped with the device built according to the present invention. The cameras comprising the device then capture images of each wheel of the vehicle, and the images are processed according to the method described hereinabove. The final result and optionally intermediate results may be displayed on a technician's computer display.

Performance details of the presented invention are presented hereinbelow. In this table, the Side column denotes the vehicle side to which the row pertains, the Front and Rear columns indicate the angles of the front and rear wheels of that side respective to the camera, the Delta column indicates the toe angle of that side, and the Toe column indicates the vehicle's toe angle (filled only for the Right rows and calculated based on the Right row and the preceding Left row).

| Side | Front | Rear | Delta | Toe | Pixel error |
|---|---|---|---|---|---|
| Left | 73.432 | 73.398 | −0.035 | | 0.5 |
| Right | 78.435 | 78.145 | −0.291 | −0.326 | 0.8 |
| Left | 73.459 | 73.227 | −0.233 | | 0.7 |
| Right | 77.781 | 77.802 | 0.021 | −0.212 | 0.6 |
| Left | 75.32 | 74.379 | −0.941 | | 0.7 |
| Right | 75.889 | 76.525 | 0.636 | −0.305 | 0.6 |
| Left | 76.233 | 78.051 | 1.818 | | 0.5 |
| Right | 75.159 | 72.951 | −2.208 | −0.39 | 0.5 |
| Left | 71.948 | 72.638 | 0.69 | | 1 |
| Right | 79.393 | 78.279 | −1.114 | −0.424 | 0.6 |
| Left | 75.7 | 75.437 | −0.263 | | 1.2 |
| Right | 76.371 | 76.194 | −0.178 | −0.441 | 0.9 |
| Left | 74.97 | 75.587 | 0.618 | | 0.6 |
| Right | 76.312 | 75.386 | −0.926 | −0.308 | 0.7 |
| Left | 73.078 | 72.533 | −0.545 | | 0.5 |
| Right | 79.058 | 79.246 | 0.189 | −0.356 | 0.6 |
| Left | 75.38 | 75.283 | −0.097 | | 0.5 |
| Right | 76.427 | 75.983 | −0.444 | −0.541 | 1.1 |
| Left | 76.496 | 76.233 | −0.263 | | 0.6 |
| Right | 75.38 | 74.969 | −0.411 | −0.674 | 0.6 |
| Left | 73.498 | 72.178 | −1.32 | | 0.9 |
| Right | 78.252 | 78.958 | 0.706 | −0.614 | 0.7 |
| Left | 75.613 | 75.373 | −0.24 | | 0.8 |
| Right | 75.87 | 75.652 | −0.218 | −0.458 | 0.4 |
| Left | 75.548 | 75.621 | 0.073 | | 0.8 |
| Right | 76.52 | 76.185 | −0.335 | −0.262 | 0.7 |
| Left | 73.696 | 75.699 | 2.003 | | 0.6 |
| Right | 77.236 | 74.991 | −2.244 | −0.241 | 0.6 |
| Left | 73.352 | 73.12 | −0.232 | | 0.9 |
| Right | 78.172 | 77.716 | −0.456 | −0.688 | 0.6 |
| Left | 75.569 | 75.651 | 0.082 | | 0.7 |
| Right | 76.725 | 75.901 | −0.825 | −0.743 | 0.7 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for determining wheel alignment of a motor vehicle, comprising:
obtaining, with one or more cameras, an image depicting at least in part a wheel of a vehicle;
analyzing the image to identify a circular component of the wheel depicted in the image;
determining a desired number of sampled points lying on an edge of the circular component;
determining an elliptic shape corresponding to the edge of the circular component;
determining an angle of the wheel depicted in the image respective to the one or more cameras as a function of geometric properties of the elliptic shape;
performing the previous steps for each wheel of the motor vehicle;
determining a left toe angle as a difference between the angles of the front left and rearmost left wheels;
determining a right toe angle as a difference between the angles of the front right and rearmost right wheels; and
outputting a sum of the left toe angle and the right toe angle.

2. The method according to claim 1, wherein determining a desired number of sampled points comprises:
determining a total number of pixels corresponding to the edge of the circular component; and
dividing the total number of pixels corresponding to the edge of the circular component by a predetermined factor.

3. The method according to claim 1, wherein determining a desired number of sampled points lying on an edge of the circular component and determining an elliptic shape corresponding to the edge of the circular component comprises:
sampling a subset of points corresponding to the edge of the circular component according to a total number of pixels corresponding to the edge of the circular component and a sampling factor;
determining an elliptic shape corresponding to the sampled subset of points corresponding to the edge of the circular component;
calculating an error metric of the elliptic shape relative to the sampled points on the edge of the circular component of the wheel segment; and
responsive to a predetermined convergence condition being met, outputting the elliptic shape, otherwise reducing the sampling factor and repeating the previous steps.

4. The method according to claim 3, wherein the error metric comprises a median Euclidean distance between points comprising the elliptic shape and respective closest points comprising the edge of the circular component.

5. The method according to claim 1, wherein determining the elliptic shape at least in part comprises the least squares method.

6. The method according to claim 1, wherein determining the elliptic shape at least in part comprises the random sample consensus method.

7. The method according to claim 1, wherein the circular component comprises a center cap of a hubcap of the wheel.

8. The method according to claim 1, wherein the circular component comprises an entirety of a hubcap of the wheel.

9. The method according to claim 1, wherein the circular component comprises a rim flange of the wheel.

10. A method for determining wheel alignment of a motor vehicle, comprising:
obtaining a first image depicting at least in part a first wheel of a vehicle with a first stereo camera, and a second image depicting at least in part a second wheel of the vehicle with a second stereo camera, wherein the first wheel and the second wheel are located on opposite sides of the vehicle;
analyzing the first image and the second image to determine a plane of the first wheel and a plane of the second wheel, respectively;
determining a first normal to the plane of the first wheel and a second normal to the plane of the second wheel;
determining a first angle between the first normal and the plane of the second wheel and a second angle between the second normal and the plane of the first wheel; and
outputting a difference between the first angle and the second angle.

11. A method for determining wheel alignment of a motor vehicle, comprising:
obtaining a first image depicting at least in part a first wheel of a vehicle and a fixed entity parallel to a longitudinal axis of the vehicle with a first stereo camera, and a second image depicting at least in part a second wheel of the vehicle and the fixed entity parallel to a longitudinal axis of the vehicle with a second stereo camera, wherein the first wheel and the second wheel are located on opposite sides of the vehicle;
analyzing the first image and the second image to determine a plane of the first wheel, a plane of the second wheel, and a plane of the fixed entity, respectively;
determining a first normal to the plane of the first wheel and a second normal to the plane of the second wheel;
determining a first angle between the first normal and the plane of the fixed entity and a second angle between the second normal and the plane of the fixed entity; and
outputting a sum of the first angle and the second angle.

12. A computer system, comprising:
a processor configured to execute stored executable instructions; and
a non-transitory computer readable medium storing executable instructions that, when executed by a processor, cause the computer system to perform a method for determining wheel alignment of a motor vehicle, the method comprising:
obtaining, with one or more cameras, an image depicting at least in part a wheel of a vehicle;
analyzing the image to identify a circular component of the wheel depicted in the image;
determining a desired number of sampled points lying on an edge of the circular component;
determining an elliptic shape corresponding to the edge of the circular component;
determining an angle of the wheel depicted in the image respective to the one or more cameras as a function of geometric properties of the elliptic shape;
performing the previous steps for each wheel of the motor vehicle;
determining a left toe angle as a difference between the angles of the front left and rearmost left wheels;
determining a right toe angle as a difference between the angles of the front right and rearmost right wheels; and
outputting a sum of the left toe angle and the right toe angle.

13. A contactless vehicle wheel toe angle measurement device, comprising:
one or more cameras configured to capture an image depicting a wheel of a vehicle;
a processor configured to execute stored executable instructions; and
a non-transitory computer readable medium storing executable instructions that, when executed by a processor, cause the computer system to perform a method for determining wheel alignment of a motor vehicle, the method comprising:
obtaining, with one or more cameras, an image depicting at least in part a wheel of a vehicle;
analyzing the image to identify a circular component of the wheel depicted in the image;
determining a desired number of sampled points lying on an edge of the circular component;
determining an elliptic shape corresponding to the edge of the circular component;
determining an angle of the wheel depicted in the image respective to the one or more cameras as a function of geometric properties of the elliptic shape;
performing the previous steps for each wheel of the motor vehicle;
determining a left toe angle as a difference between the angles of the front left and rearmost left wheels;
determining a right toe angle as a difference between the angles of the front right and rearmost right wheels; and
outputting a sum of the left toe angle and the right toe angle.

14. The device according to claim 13, further comprising a mechanical mount, wherein the one or more cameras are installed on the mechanical mount, the mechanical mount being configured to reposition the one or more cameras along a longitudinal axis of the vehicle.

15. The device according to claim 14, wherein the mechanical mount comprises a conveyor belt system.

16. The device according to claim 14, wherein the mechanical mount comprises a linear actuator system.

17. The device according to claim 14, wherein the mechanical mount comprises a sliding rail system.

18. The device according to claim 13, further comprising a mechanical mount, wherein the one or more cameras are installed on the mechanical mount, the mechanical mount being configured to reposition the one or more cameras at least in part along both a longitudinal and a lateral axes of the vehicle.

19. The device according to claim 18, wherein the mechanical mount comprises a robotic arm with at least one degree of freedom.

20. The device according to claim 18, wherein the mechanical mount comprises an overhead gantry system.
